(19) United States
(12) Patent Application Publication
(10) Pub. No.: US 2024/0314345 A1
(43) Pub. Date: Sep. 19, 2024

(54) REFERENCE MOTION VECTOR CANDIDATE BANK

(71) Applicant: GOOGLE LLC, Mountain View, CA (US)

(72) Inventors: Hui Su, Sunnyvale, CA (US); Debargha Mukherjee, Cupertino, CA (US)

(21) Appl. No.: 18/577,831

(22) PCT Filed: Jul. 15, 2021
(86) PCT No.: PCT/US2021/041831

§ 371 Date: Jan. 9, 2024

(51) Int. Cl. H04N 19/513; H04N 19/105; H04N 19/119; H04N 19/139; H04N 19/159; H04N 19/176

(52) U.S. Cl. CPC H04N 19/513; H04N 19/105; H04N 19/119; H04N 19/139; H04N 19/159; H04N 19/176

(57) ABSTRACT

A method for inter-prediction includes coding a first block of a current frame using a first motion vector (MV) and a reference frame type; storing, in at least one MV buffer, the first MV and the reference frame type; identifying MV candidates for coding a current block using the reference frame type; responsive to a determination that a cardinality of the MV candidates is less than a maximum number of MV candidates identifying the first motion vector in the at least one MV buffer, and responsive to a determination that the first MV is not included in the MV candidates, adding the first MV as an MV candidate; and selecting one of the MV candidates for coding the current block.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission or storage of the video data. Various approaches have been proposed to reduce the amount of data in video streams, including compression and other encoding techniques.

### SUMMARY

This disclosure relates generally to encoding and decoding video data and more particularly relates to encoding and decoding blocks of video frames using reference motion vector candidate banks.

A first aspect is a method for inter-prediction. The method includes coding a first block of a current frame using a first motion vector (MV) and a reference frame type, storing, in at least one MV buffer, the first MV and the reference frame type, identifying MV candidates for coding a current block using the reference frame type, responsive to a determination that a cardinality of the MV candidates is less than a maximum number of MV candidates, identifying the first motion vector in the at least one MV buffer, and responsive to a determination that the first MV is not included in the MV candidates, adding the first MV as an MV candidate, and selecting one of the MV candidates for coding the current block.

A second aspect is an apparatus for inter-prediction that includes a processor. The processor is configured to obtain a partitioning of a current frame into superblocks arranged into rows of superblocks, initialize row MV banks, where each row MV bank is associated with one or more rows of superblocks and one or more reference frame types, code a first block of a first superblock of the superblocks using a first motion vector (MV) and a reference frame type, where the first block is in a row of superblocks, store, in a row MV bank associated with the row of superblocks and the reference frame type, the first MV, obtain MV candidates for coding a second block of a second superblock using the reference frame type, and, on a condition that a cardinality of the MV candidates being less than a maximum number of MV candidates, use the reference frame type and the row MV bank associated with the row of superblocks to identify additional MV candidates for coding the second block.

A third aspect is a method for decoding a current block of a current frame. The method includes storing first motion vectors (MVs) of first blocks decoded before the current block in a row MV bank that is associated with a row of superblocks that includes the first blocks and the current block, obtaining candidate MVs for decoding the current block, where the candidate MVs are stored in slots of a candidate MV list and a cardinality of the candidate MVs is smaller than a size of the candidate MV list, using the row MV bank to add first additional MV candidates to the candidate MV list, and decoding the current block using a candidate MV of the candidate MV list.

These and other aspects of the present disclosure are disclosed in the following detailed description of the embodiments, the appended claims, and the accompanying figures.

### BRIEF DESCRIPTION OF THE DRAWINGS

The description herein makes reference to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6 is a block diagram of an example of a reference frame buffer.

FIG. 7A is a diagram of an example of a multi-layer coding structure.

FIG. 7B is a diagram of an example of a one-layer coding structure.

FIG. 8 is a diagram of an example of a search area for candidate motion vectors.

FIG. 9 is a flowchart diagram of a technique for inter-prediction.

FIG. 10 is a diagram of an example of motion vector banks.

FIG. 11 is a flowchart diagram of a technique for adding a motion vector to a motion vector buffer.

FIG. 12 illustrates scenarios of adding a motion vector to a motion vector buffer.

FIG. 13 illustrates an example of adding candidate motion vectors to a candidate motion vector list from a motion vector buffer.

FIG. 14 is a flowchart diagram of a technique for obtaining motion vector candidates.

FIG. 15 is a flowchart diagram of a technique for decoding a current block.

### DETAILED DESCRIPTION

Compression schemes related to coding video content (e.g., video streams, video files, etc.) may include breaking each image into blocks and generating a digital video output bitstream using one or more techniques to limit the information included in the output. A received bitstream can be decoded to re-create the blocks and the source images from the limited information. Encoding a video stream, or a portion thereof, such as a frame or a block, can include using temporal and spatial similarities in the video stream to improve coding efficiency. For example, a current block of a video stream may be encoded based on a previously coded block in the video stream by predicting motion and color information for the current block based on the previously coded block and identifying a difference (residual) between the predicted values and the current block. In this way, only the residual and parameters used to generate the residual need be added to the bitstream instead of including the entirety of the current block. This technique may be referred to as inter prediction.

One of the parameters used in inter prediction is a motion vector (MV) that represents the spatial displacement of the previously coded block relative to the current block. The MV can be identified using a method of motion estimation, such as a motion search. In motion search, a portion of a reference frame can be translated to a succession of locations to form a prediction block that can be subtracted from a portion of a current frame to form a series of residuals. The horizontal and vertical translations corresponding to the location having the smallest residual can be selected as the MV. Bits representing the MV can be included in the encoded bitstream to permit a decoder to reproduce the prediction block and decode the portion of the encoded video bitstream associated with the MV.

For video compression schemes, the coding of MVs often consumes a large percentage of the overall bitrate, especially for video streams encoded at lower data rates or higher compression ratios. To improve the encoding efficiency, an MV can be differentially encoded using a reference MV. That is, only the difference (residual) between the MV and the reference MV is encoded. In some instances, the reference MV can be selected from previously used MVs in the video stream, for example, the last non-zero MV from neighboring blocks. Selecting a previously used MV to encode a current MV (i.e., the MV of a current block being encoded) can further reduce the number of bits included in the encoded video bitstream and thereby reduce transmission and storage bandwidth requirements. Motion vector referencing modes allow a coding block to infer motion information from previously coded neighboring blocks.

The reference MV can be selected from a list of candidate reference MVs (also referred to MV candidates). Different techniques have been developed for obtaining (e.g., selecting, choosing, determining, etc.) the list of MV candidates from previously coded neighboring blocks. Illustrative techniques for obtaining MV candidates are described herein. However, the disclosure herein is not limited to any particular technique for obtaining a list of candidate reference MVs.

For example, H.265/HEVC uses Advanced Motion Vector Prediction (AMVP) to construct a list of MV candidates. To illustrate, in H.265, a two-pass technique is used to obtain the list of candidate reference motion vectors. In a first pass, the codec checks whether any of designated neighboring blocks contain (e.g., use, etc.) a reference frame index that is equal to the reference frame index of a current block being coded. The first motion vector that is found can be taken as candidate MV. In a second pass, which may not be used, motion vectors of one or more of the designated neighboring blocks can be scaled using a scaling factor. The scaling factor can be calculated based on a first temporal distance between the current frame that includes the current block to be coded and the reference frame of the candidate neighboring block and a second temporal distance between the current frame and the reference frame of the current block.

In another example, such as in AV1, the MV candidates can include motion vectors from previously coded (encoded or decoded) blocks in the video stream, such as a block (e.g., a mode unit) from a previously coded (or decoded) frame, or a block from the same frame that has been previously encoded (or decoded). The candidate reference blocks may include a co-located block (of the current block) and its surrounding blocks in a reference frame. For example, the surrounding blocks can include a block to the right, bottom-left, bottom-right, or below the co-located block. As such, the search area of previously coded blocks is limited. One or more candidate reference frames, including single and compound reference frames, can be used.

In an example, a candidate MV can be selected from candidate reference motion vectors based on the distance between the reference block and the current block and the popularity of the reference motion vector. For example, the distance between the reference block and the current block can be based on the spatial displacement between the pixels in the previously coded block and the collocated pixels in the current block, measured in the unit of pixels. For example, the popularity of the motion vector can be based on the amount of previously coded pixels that use the motion vector. The more previously coded pixels that use the motion vector, the higher the probability of the motion vector. In one example, the popularity value is the number of previously coded pixels that use the motion vector. In another example, the popularity value is a percentage of previously coded pixels within an area that use the motion vector.

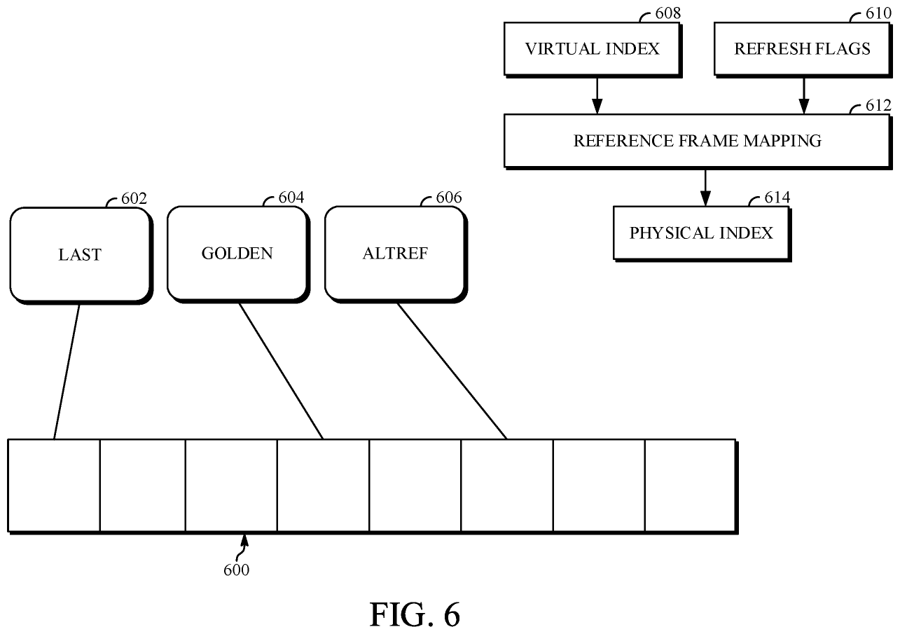

A prediction mode for encoding a current block can also be encoded and transmitted so a decoder can use the same prediction mode(s) to form prediction blocks in the decoding and reconstruction process. In the case of inter-prediction, the prediction mode may be selected from one of multiple inter-prediction modes using one or more reference frames. A current block may be encoded using a single reference frame prediction mode using one corresponding motion vector, which may be referred to as single-reference prediction; or a compound reference frame prediction mode using two reference frames using two corresponding motion vectors, which may be referred to as compound-reference prediction. For ease of reference, MV as used herein, and unless otherwise clear from the context, may be used to refer to one motion vector (such as in the case of the single reference frame) or two motion vectors (such as in the case of compound reference frames) as the distinction between one or two reference frames is not necessary for understanding this disclosure. The reference frames available for coding a current block may be available (e.g., stored, etc.) in a reference frame buffer. An example of a reference frame buffer is described with respect to FIG. 6.

In an example, up to seven reference frames may be available coding a block using the single reference frame prediction mode or the compound reference frame prediction mode. With respect to the compound reference frame prediction mode, combinations of reference frames may be used. In an example, any two reference frames may be used in the compound reference frame prediction mode. As such, any combination of two out of the seven (e.g., C(7,2)) available reference frames (e.g., 28 possible combinations) may be used. In another example, only a subset of all of the possible combinations may be valid (e.g., used for coding a current block).

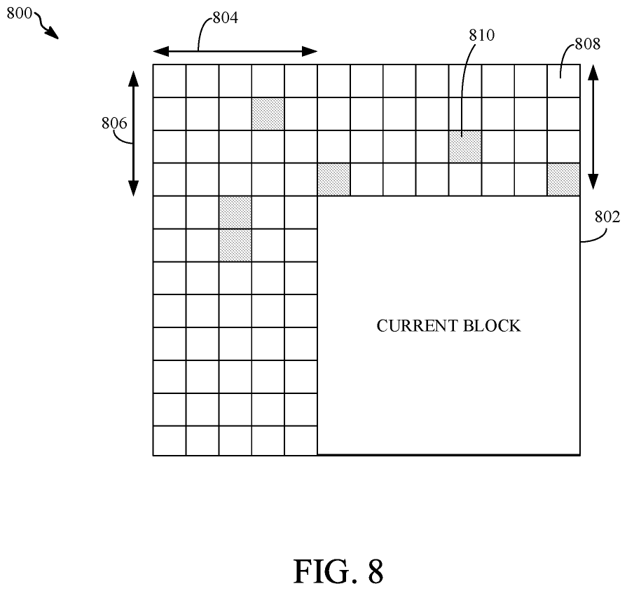

In an example, a bitstream syntax may support three categories of inter-prediction modes. The inter-prediction modes can include, for example, a mode (sometimes called ZERO_MV mode) in which a block from the same location within a reference frame as the current block is used as the prediction block; a mode (sometimes called a NEW_MV mode) in which a motion vector is transmitted to indicate the location of a block within a reference frame to be used as the prediction block relative to the current block; or a mode (sometimes called a REF_MV mode comprising NEAR_MV or NEAREST_MV mode) in which no motion vector is transmitted and the current block uses the last or second-to-last non-zero motion vector used by neighboring, previously coded blocks to generate the prediction block. Inter-prediction modes may be used with any of the available reference frames. The NEAR_MV and NEAREST_MV can indicate which set of neighboring blocks (i.e., units of pixels) are used to obtain the reference motion vector. For example, the NEAREST_MV can indicate units of pixels that are closer to the current block than the units of pixels indicated by the NEAR_MV. Units of pixels are illustrated with respect to FIG. 8.

To summarize, in some examples, for an inter-coded current block, a list of candidate MVs can be generated, which typically consists of the MVs of nearby blocks (e.g., unit modes) that use the same reference frame(s) as the current block or scaled MVs of nearby blocks that do not use the same reference frame as the current block. One of the MVs in the list can be selected as the reference MV for coding the block. The reference MV can be directly used for inter prediction (such as in the case of the NEAREST_MV or NEAR_MV modes). Otherwise, a delta can be applied to the reference MV to form a final MV (such as in the case of the NEW_MV mode). The reference MV candidate list can be generated by scanning the spatial and temporal neighboring coded blocks of the current block and fetching MVs corresponding to the same reference frames used by the current block. The range of the scanning (for spatial neighbors) is limited to a number of units of pixels (e.g., 5 units of pixels where each unit is 4 pixels) above and to the left of the current block.

The list of candidate MVs has a fixed size. Each of the identified candidate MVs occupies a respective location (e.g., slot, etc.) of the list of candidate MVs. In some situations, the number (e.g., cardinality, etc.) of identified candidate MVs may be smaller than the number of slots of the list of candidate reference motion vectors.

A limitation of conventional techniques for obtaining candidate MVs, such as those described above, is that the MVs of blocks further away from the current block (referred to herein as distant blocks) are not utilized, such as due to constraints on the scanning range. Scanning range refers to the set of blocks or units of pixels typically used to obtain the candidate MVs.

Implementations according to this disclosure can provide additional reference MV candidates. MV buffers can be used to store MVs of blocks as the blocks are coded. When coding a current block, the buffers can be used to identify additional candidate MVs in cases where more slots remain available in the list of candidate MVs after the candidate MVs are identified using conventional scanning techniques. The additional candidate MVs can be identified using the MVs of distant blocks to the current block. Distant blocks refers to blocks (e.g., unit modes) that are not conventionally searched (i.e., are outside a search range) to identify the candidate MVs for the current block.

In an example, the MV buffers can be updated (e.g., one or more MVs can be added to respective MV buffers) after a block is coded. In an example, MV buffers can be updated after all blocks of a superblock that includes the block are coded. A superblock is a block having a largest block size. In an example a superblock can be a 128×128 or a 64×64 pixels. A superblock may also be referred to as a macroblock. Subsequent to the performance of a conventional (such as described above) reference MV candidate generation, if there are open slots in the list of MV candidates, a codec, according to implementations of this disclosure, can reference (e.g., search, use, etc.) the MV candidate buffers for additional MV candidates.

In an example, MV buffers can be grouped into MV banks. As further explained below, several reference frame types may be available coding blocks of a frame. MV buffers can be associated reference frame types. A reference MV candidate bank (or an MV bank) refers to a collection (e.g., a set) of MV buffers where the collection can include an MV buffer for each possible reference frame type. Experiments have shown that reference motion vector candidate buffers (or banks) can result in more than 0.5% Peak signal-to-noise ratio (PSNR) gains over the AV1 baseline.

Further details of a reference motion vector candidate bank are described herein with initial reference to a system in which the bank can be implemented.

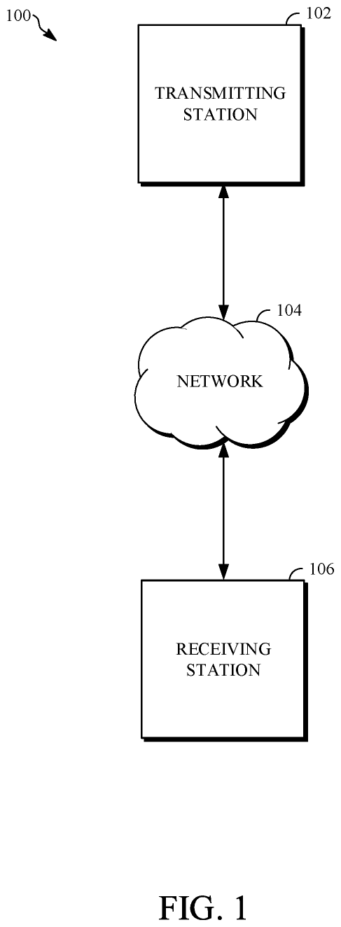

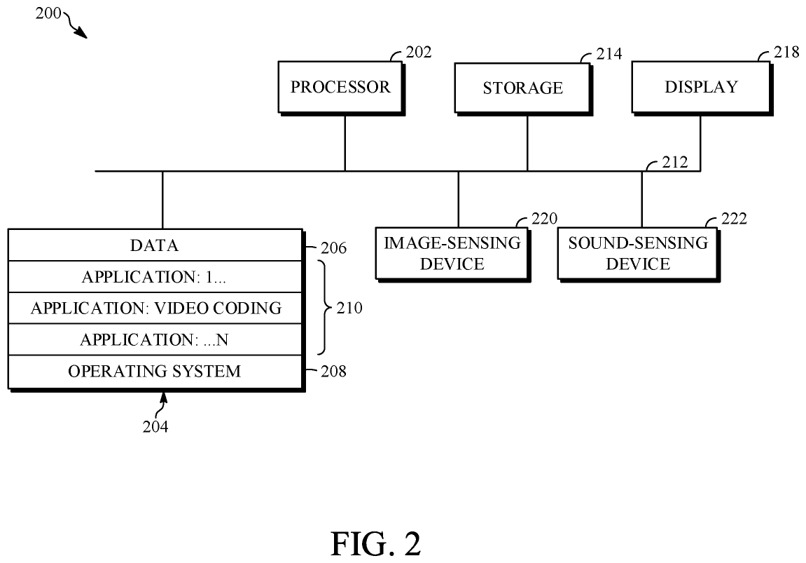

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now-existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

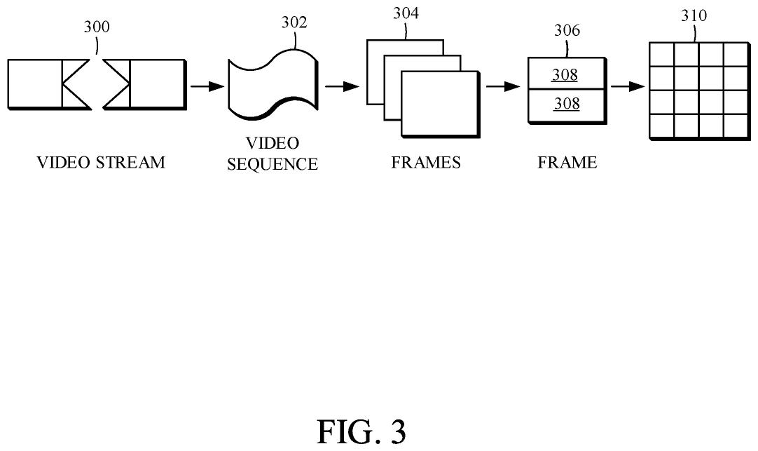

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

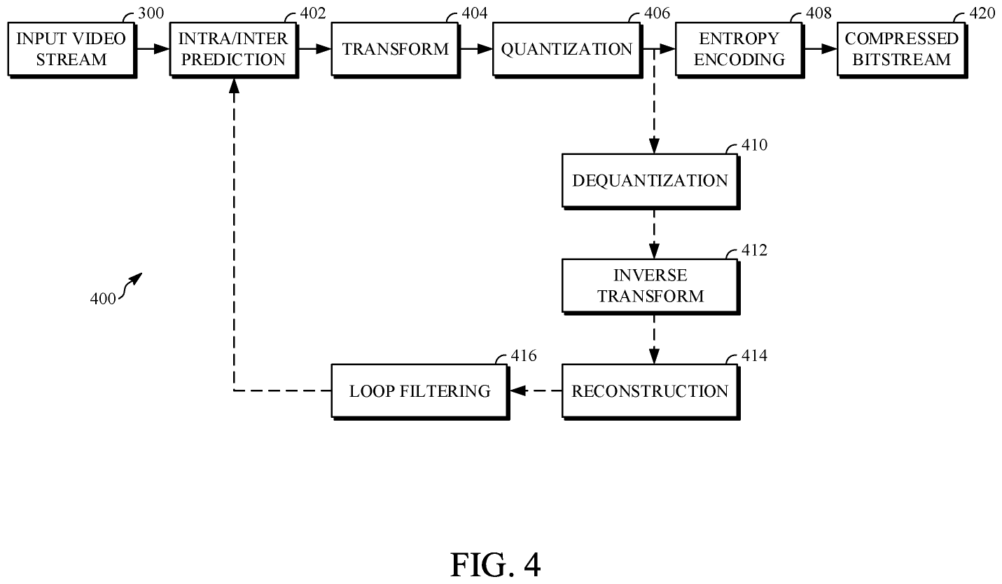

FIG. 4 is a block diagram of an encoder 400 according to implementations of this disclosure. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform based encoder can quantize the residual signal directly without the transform stage 404 for certain blocks or frames. In another implementation, an encoder can have the quantization stage 406 and the dequantization stage 410 combined in a common stage.

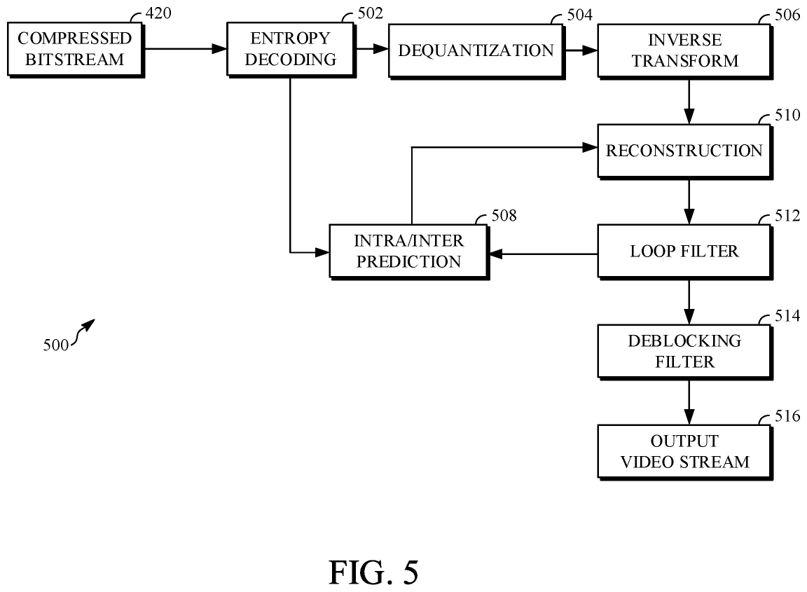

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the deblocking filtering stage 514.

FIG. 6 is a block diagram of an example of a reference frame buffer 600. The reference frame buffer 600 stores reference frames used to encode or decode blocks of frames of a video sequence. Labels, roles, or types may be associated with or used to describe different reference frames stored in the reference frame buffer. The reference frame buffer 600 is provided as an illustration and operation of a reference frame buffer, and implementations according to this disclosure may not result in reference frames as described with respect to FIG. 6.

The reference frame buffer 600 includes a last frame LAST 602, a golden frame GOLDEN 604, and an alternative reference frame ALTREF 606. The frame header of a reference frame can include a virtual index 608 to a location within the reference frame buffer 600 at which the reference frame is stored. A reference frame mapping 612 can map the virtual index 608 of a reference frame to a physical index 614 of memory at which the reference frame is stored. Where two reference frames are the same frame, those reference frames can have the same physical index even if they have different virtual indexes. One or more refresh flags 610 can be used to remove one or more of the stored reference frames from the reference frame buffer 600, for example, to clear space in the reference frame buffer 600 for new reference frames, where there are no further blocks to encode or decode using the stored reference frames, or where a new golden frame is encoded or decoded.

The reference frames stored in the reference frame buffer 600 can be used to identify motion vectors for predicting blocks of frames to be encoded or decoded. Different reference frames may be used depending on the type of prediction used to predict a current block of a current frame. For example, in an inter-inter compound prediction, blocks of the current frame can be forward predicted using any combination of the last frame LAST 602, the golden frame GOLDEN 604, and the alternative reference frame ALTREF 606.

There may be a finite number of reference frames that can be stored within the reference frame buffer 600. As shown in FIG. 6, the reference frame buffer 600 can store up to eight reference frames. Each of the stored reference frames can be associated with a respective virtual index 608 of the reference frame buffer. Although three of the eight spaces in the reference frame buffer 600 are used by the last frame LAST 602, the golden frame GOLDEN 604, and the alternative reference frame ALTREF 606, five spaces remain available to store other reference frames.

In particular, one or more available spaces in the reference frame buffer 600 may be used to store additional alternative reference frames (e.g., ALTREF1, ALTREF2, EXTRA ALTREF, etc., wherein the original alternative reference frame ALTREF 606 could be referred to as ALTREF0). The alternative reference frame ALTREF 606 is a frame of a video sequence that is distant from a current frame in a display order, but is encoded or decoded earlier than it is displayed. For example, the alternative reference frame ALTREF 606 may be ten, twelve, or more (or fewer) frames after the current frame in a display order.

The additional alternative reference frames can be frames located nearer to the current frame in the display order. For example, a first additional alternative reference frame, ALTREF2, can be five or six frames after the current frame in the display order, whereas a second additional alternative reference frame, ALTREF3, can be three or four frames after the current frame in the display order. Being closer to the current frame in display order increases the likelihood of the features of a reference frame being more similar to those of the current frame. As such, one of the additional alternative reference frames can be stored in the reference frame buffer 600 as additional options usable for backward prediction.

Although the reference frame buffer 600 is shown as being able to store up to eight reference frames, other implementations of the reference frame buffer 600 may be able to store additional or fewer reference frames. Furthermore, the available spaces in the reference frame buffer 600 may be used to store frames other than additional alternative reference frames. For example, the available spaces may store a second last frame LAST2 and/or a third last frame LAST3 as additional forward prediction reference frames. In another example, a backward frame BWDREF may be stored as an additional backward prediction reference frame.

As mentioned above, the frames of a group of pictures (GOP) may be coded in a coding order that is different from the display order of the frames. For example, an encoder may receive the frames in the display order, determine a coding order (or a coding structure), and encode the group of frames accordingly. For example, a decoder may receive the frames (e.g., in an encoded bitstream) in the coding order, decode the frames in the coding order, and display the frames in the display order. As frames are coded (i.e., encoded by an encoder or decoded by a decoder), they may be added to the reference frame buffer 600 and assigned different roles (e.g., LAST, GOLDEN, ALTREF, LAST2, LAST3, BWDREF, etc.) for the coding of a subsequent frame. That is, some frames that are coded first may be stored in the reference frame buffer 600 and used as reference frames for the coding (using inter-prediction) of other frames. For example, the first frame of a GOP may be coded first and assigned as a GOLDEN frame, and the last frame within a GOP may be coded second, assigned as an alternative reference (i.e., ALTREF) for the coding of all the other frames.

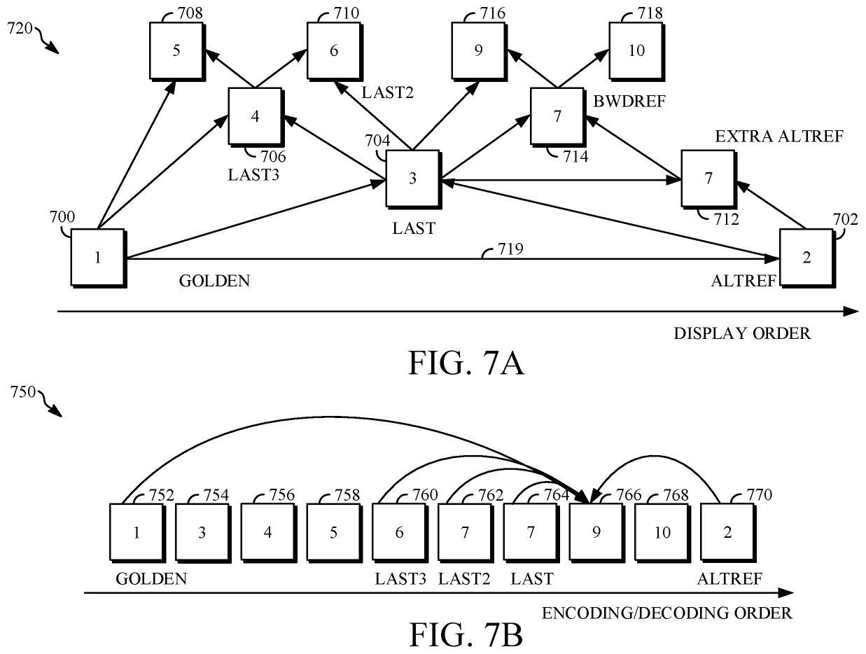

The frames of a GOP can be encoded using a coding structure. A coding structure, as used herein, refers to the order of coding of the frames of the GOP and/or which reference frames are available for coding which other frames of the GOP. Hereinafter a GOP is referred to as a group of frames (GF) group. To illustrate the concept of coding structures, and without loss of generality or without any limitations as to the present disclosure, a multi-layer coding structure and a one-layer coding structure are described below with respect to FIGS. 7A and 7B, respectively. It is noted that, when referring to an encoder, coding means encoding; and when referring to a decoder, coding means decoding.

The frames of a GF group may be coded independently of the frames of other GF groups. In the general case, the first frame of the GF group is coded using intra prediction and all other frames of the GF group are coded using frames of the GF group as reference fames. In some cases, the first frame of the GF group can be coded using frames of a previous GF group. In some cases, the last frame of the GF group can be coded using frames of a previous GF group. In some cases, the first and the last frame of a GF group may be coded using frames of prior GF groups.

In an example, three reference frames may be available to encode or decode blocks of other frames of the video sequence. The first reference frame may be an intra-predicted frame, which may be referred to as a key frame or a golden frame. In some coding structures, the second reference frame may be a most recently encoded or decoded frame. The most recently encoded or decoded frame may be referred to as the LAST frame. The third reference frame may be an alternative reference frame that is encoded or decoded before most other frames, but which is displayed after most frames in an output bitstream. The alternative reference frame may be referred to as the ALTREF frame. The efficacy of a reference frame when used to encode or decode a block can be measured based on the resulting signal-to-noise ratio.

FIG. 7A is a diagram of an example of a multi-layer coding structure 720 according to implementations of this disclosure. The multi-layer coding structure 720 shows a coding structure of a GF group of length 10 (i.e., the group of frames includes 10 frames), here frames 700 through 718.

An encoder, such as the encoder 400 of FIG. 4, can encode a group of frames according to the multi-layer coding structure 720. A decoder, such as the decoder 500 of FIG. 5, can decode the group of frames using the multi-layer coding structure 720. The decoder can receive an encoded bitstream, such as the compressed bitstream 420 of FIG. 5. In the encoded bitstream, the frames of the group of frames can be ordered (e.g., sequenced, stored, etc.) in the coding order of the multi-layer coding structure 720. The decoder can decode the frames in the multi-layer coding structure 720 and display them in their display order. The encoded bitstream can include syntax elements that can be used by the decoder to determine the display order.

The numbered boxes of FIG. 7A indicate the coding order of the group of frames. As such, the coding order is given by the frame order: 700, 702, 704, 706, 708, 710, 712, 714, 716, and 718. The display order of the frames of the group of frames in indicated by the left-to-right order of the frames. As such, the display order is given by the frame order: 700, 708, 706, 710, 704, 716, 714, 718, 712, and 702. That is, for example, the second frame in the display order (i.e., the frame 708) is the 5^{th} frame to be coded; the last frame of the group of frames (i.e., the frame 702) is the second frame to be coded.

In FIG. 7A, the first layer includes the frames 700 and 702, the second layer includes the frames 704 and 712, the third layer includes the frames 706 and 714, and the fourth layer includes the frames 708, 710, 716, and 718. The frames of a layer do not necessarily correspond to the coding order. For example, while the frame 712 (corresponding to coding order 7) is in the second layer, frame 706 (corresponding to coding order 4) of the third layer and frame 708 (corresponding to coding order 5) of the fourth layer are coded before the frame 712.

In a multi-layer coding structure, such as the multi-layer coding structure 720, the frames within a GF group may be coded out of their display order and the coded frames can be used as backward references for frames in different (i.e., higher) layers.

The coding structure of FIG. 7A is said to be a multi-layer coding structure because frames of a layer are coded using, as reference frames, only coded frames of lower layers and coded frames of the same layer. That is, at least some frames of lower layers and frames of the same layer of a current frame (i.e., a frame being encoded) can be used as reference frames for the current frame. A coded frame of the same layer as the current frame is a frame of the same layer as the current frame and is coded before the current frame. For example, the frame 712 (coding order 7) can be coded using frames of the first layer (i.e., the frames 700 and 702) and coded frames of the same layer (i.e., the frame 704). As another example, the frame 710 (coding order 6) can be coded using already coded frames of the first layer (i.e., the frames 700 and 702), already coded frames of the second layer (i.e., the frame 704), already coded frames of the third layer (i.e., the frame 706), and already coded frames of the same layer (i.e., the frame 708). Which frames are actually used to code a frame depends on the roles assigned to the frames in the reference frame buffer.

The arrows in FIGS. 7A and 7B illustrate partial examples of which frames can be used, as reference frames, for coding a frame. For example, as indicated by the arrows, the frame 700 can be used to code the frame 702, the frames 700 and 702 can be used to code the frame 704, and so on. However, as already mentioned, for the sake of reducing clutter, only a subset of the possible arrows is displayed. For example, as indicated above, the frames 700 and 702 can be used for coding any other frame of the group of frames; however, no arrows are illustrated, for example, between the frames 700 and/or 702 and the frames 710, 716, 718, etc.

In an implementation, the number of layers and the coding order of the frames of the group of frames can be selected by an encoder based on the length of the group of frames. For example, if the group of frames includes 10 frames, then the multi-layer coding structure of FIG. 7A can be used. In another example, if the group of frames includes nine (9) frames, then the coding order can be frames 1, 9, 8, 7, 6, 5, 4, 3, and 2. That is, for example, the 3^{rd} frame in the display order is the coded 8^{th} frame in the coding order. A first layer can include the 1^{st} and 9^{th} frames in the display order, a second layer can include the 5^{th} frame in the display order, a third layer can include the 3^{rd} and 7^{th} frames in the display order, and a fourth layer can include the 2^{nd}, 4^{th}, 6^{th}, and 8^{th} frames in the display order.

As mentioned above, the coding order for each group of frames can differ from the display order. This allows a frame located after a current frame in the video sequence to be used as a reference frame for encoding the current frame. A decoder, such as the decoder 500, may share a common group coding structure with an encoder, such as the encoder 400. The group coding structure assigns different roles that respective frames within the group may play in the reference frame buffer (e.g., a last frame, an alternative reference frame, etc.) and defines or indicates the coding order for the frames within a group.

In a multi-layer coding structure, the first frame and last frame (in display order) are coded first. As such, the frame 700 (the first in display order) is coded first and the frame 702 (the last in display order) is coded next. The first frame of the group of frames can be referred as (i.e., has the role of) the GOLDEN frame such as described with respect to the golden frame GOLDEN 604 of FIG. 6. The last frame in the display order (e.g., the frame 702) can be referred to as (i.e., has the role of) the ALTREF frame, as described with respect to the alternative reference frame ALTREF 606 of FIG. 6.

In coding blocks of each of the frames 704 through 718, the frame 700 (as the golden frame) is available as a forward prediction frame and the frame 702 (as the alternative reference frame) is available as a backward reference frame. Further, the reference frame buffer, such as the reference frame buffer 600, is updated after coding each frame so as to update the identification of the reference frame, also called a last frame (e.g., LAST), which is available as a forward prediction frame in a similar manner as the frame 700. For example, when blocks of the frame 706 are being predicted (e.g., at the intra/inter prediction stage 402), the frame 708 can be designated the last frame (LAST), such as the last frame LAST 602 in the reference frame buffer 600. When blocks of the frame 708 are being predicted, the frame 706 is designated the last frame, replacing the frame 704 as the last frame in the reference frame buffer. This process continues for the prediction of the remaining frames of the group in the encoding order.

The first frame can be encoded using inter-prediction or intra-prediction. In the case of inter-prediction, the first frame can be encoded using frames of a previous GF group. The last frame can be encoded using intra-prediction or inter-prediction. In the case of inter-prediction, the last frame can be encoded using the first frame (e.g., the frame 700) as indicated by the arrow 719. In some implementations, the last frame can be encoded using frames of a previous GF group. All other frames (i.e., the frames 704-718) of the group of frames are encoded using encoded frames of the group of frames as described above.

The GOLDEN frame (i.e., the frame 700) can be used as a forward reference and the ALTREF (i.e., the frame 702) can be used as a backward reference for coding the frames 704 through 718. As every other frame of the group of frames (i.e., the frames 704 through 718) has available at least one past frame (e.g., the frame 700) and at least one future frame (e.g., the frame 702), it is possible to code a frame (i.e., to code at least some blocks of the frame) using one reference or two references (e.g., an inter-inter compound prediction mode).

In a multi-layer coding structure, some of the layers can be assigned roles. For example, the second layer (i.e., the layer that includes the frames 704 and 712) can be referred to as the EXTRA ALTREF layer, and the third layer (i.e., the layer that includes the frames 706 and 714) can be referred to as the BWDREF layer. The frames of the EXTRA ALTREF layer can be used as additional alternative prediction reference frames. The frames of the BWDREF layer can be used as additional backward prediction reference frames. If a GF group is categorized as a non-still GF group (i.e., when a multi-layer coding structure is used), BWDREF frames and EXTRA ALTREF frames can be used to improve the coding performance.

FIG. 7B is a diagram of an example of a one-layer coding structure 750 according to implementations of this disclosure. The one-layer coding structure 750 can be used to code a group of frames.

An encoder, such as the encoder 400 of FIG. 4, can encode a group of frames according to the one-layer coding structure 750. A decoder, such as the decoder 500 of FIG. 5, can decode the group of frames using the one-layer coding structure 750. The decoder can receive an encoded bitstream, such as the compressed bitstream 420 of FIG. 5. In the encoded bitstream, the frames of the group of frames can be ordered (e.g., sequenced, stored, etc.) in the coding order of the one-layer coding structure 750. The decoder can decode the frames in the one-layer coding structure 750 and display them in their display order. The encoded bitstream can include syntax elements that can be used by the decoder to determine the display order.

The display order of the group of frames of FIG. 7B is given by the left-to-right ordering of the frames. As such, the display order is 752, 754, 756, 758, 760, 762, 764, 766, 768, and 770. The numbers in the boxes indicate the coding order of the frames. As such, the coding order is 752, 770, 754, 756, 758, 760, 762, 764, 766, and 768.

To code any of the frames 754, 756, 758, 760, 762, 764, 766, and 768 in the one-layer coding structure 750, except for the distant ALTREF frame (e.g., the frame 770), no other backward reference frames are used. Additionally, in the one-layer coding structure 750, the use of the BWDREF layer (as described with respect to FIG. 7A), the EXTRA ALTREF layer (as described with respect to FIG. 7A), or both is disabled. That is, no BWDREF and/or EXTRA ALTREF reference frames are available for coding any of the frames 754 through 768. Multiple references can be employed for the coding of the frames 754 through 768. Namely, the reference frames LAST, LAST2, LAST3, and GOLDEN, coupled with the use of the distant ALTREF, can be used to encode a frame. For example, the frame 752 (GOLDEN), the frame 760 (LAST3), the frame 762 (LAST2), the frame 764 (LAST), and the frame 770 (ALTREF) can be available in the reference frame buffer, such as the reference frame buffer 600, for coding the frame 766.

FIG. 8 is a diagram of an example 800 of a search area for candidate motion vectors. The example 800 is used for illustration purposes and does not limit this disclosure, and other conventional ways of obtaining candidate motion vectors are possible. As mentioned herein, when coding a current block (e.g., a current block 802) using a reference frame (e.g., using a reference frame type), a codec obtains (e.g., generates, selects) a list of candidate motion vectors. The candidate MVs are identified in a scanning area adjacent to the current block.

The scanning area can be measured in mode units, such as a mode unit 808. A mode unit can be a smallest block size for which inter-prediction is possible. For example, some codecs may not perform inter-prediction for blocks smaller than M×N pixels. In an example, M=N=4. As such, mode units can be 4×4 pixels in size. The scanning area can have a height 806 above the current block 802 and a width 804 to the left of the current block 802. The height 806 and the width 804 can be measured in mode units (or equivalently, in pixels).

Each mode unit can be associated with mode information. The mode information can include a reference frame type and a motion vector used for predicting the mode unit. Even though mode information is associated with a mode unit, the mode unit may not necessarily be independently coded from other mode units. To illustrate, a block of size P×Q (where P≥M, and Q≥N) may be predicted, without being further partitioned, using mode information. The mode information can be associated with each M×N mode unit of the P×Q block. To illustrate further, a superblock of size 128×128 may be inter-predicted without being further partitioned. As such, the motion vector and the reference frame type can be associated with all non-overlapping 4×4 mode units of the superblock.

Shaded mode units (such as a mode unit 810) illustrate mode units of the scanning area that use a same reference frame as the current block 802. As such the shaded mode units can be used to obtain candidate MVs for the current block 802.

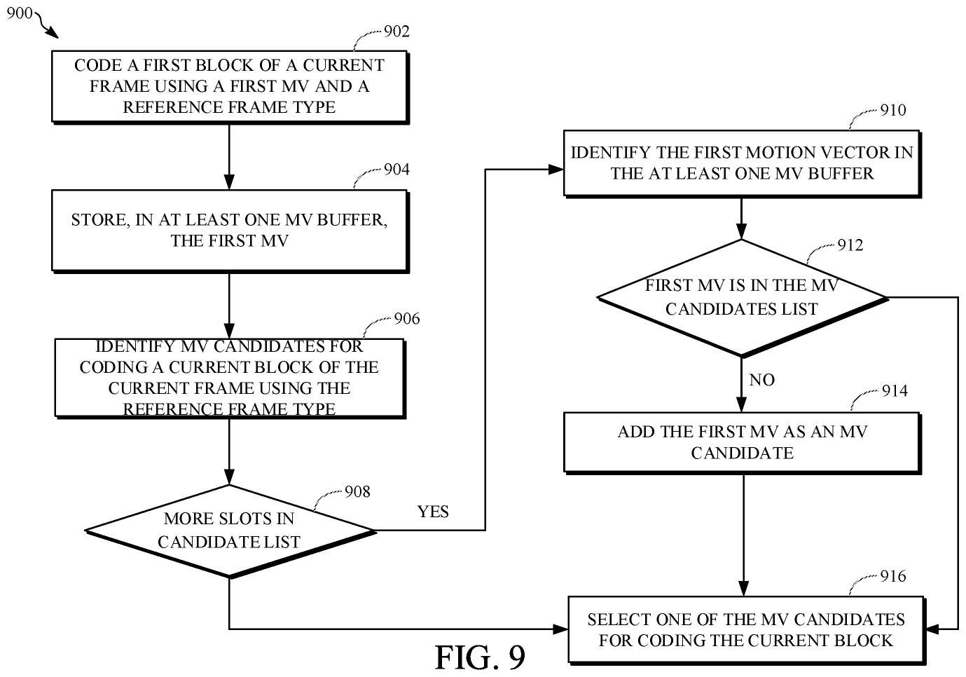

FIG. 9 is a flowchart diagram of a technique 900 for inter-prediction. The technique 900 may be implemented in whole or in part in the intra/inter prediction stage 402 of the encoder 400 of FIG. 4 and/or the intra/inter prediction stage 508 of the decoder 500 of FIG. 5. When implemented in an encoder, “to code” means “to encode”; when implemented by a decoder, “to code” means “to decode”.

The technique 900 can be implemented, for example, as a software program that may be executed by computing devices such as the transmitting station 102 or the receiving station 106 of FIG. 1. For example, the software program can include machine-readable instructions that may be stored in a memory such as the memory 204 or the secondary storage 214 of FIG. 2, and that, when executed by a processor, such as CPU 202 of FIG. 2, may cause the computing device to perform the technique 900. The technique 900 can be implemented using specialized hardware or firmware. As explained above, some computing devices may have multiple memories or processors, and the operations described in the technique 900 can be distributed using multiple processors, memories, or both. The technique 900 can be implemented using specialized hardware or firmware. Multiple processors, memories, or both, may be used.

The technique 900 can be used to obtain candidate MVs for coding a current block of a current frame. The current block is coded using a reference frame of a certain type. Several frames types may be available. In an example, frame types can be as described with respect to FIG. 6. As such, in the case that a block is predicted using one single reference frame, the frame types can be one of seven frame types ALTREF, ALTREF2, LAST, LAST2, LAST3, GOLDEN, BWDREF, fewer, more, other frame types, or a combination thereof. In the case that a block is predicted using a compound reference frame, the frame type can be a combination of two of the singular frame types. As such, assuming that seven singular frame types are available, then a total of 28 frame types (7 singular+(C(7,2)=21) compound frame types) may be available.

The current frame may be partitioned into partitions (e.g., tiles, segments, etc.). Each partition can include rows and columns of superblocks. It is noted that depending on the partitioning scheme, one row (column) of the partition may include more superblocks than a second row (column) of the partition.

In an example, one of more MV buffers can be available for storing MVs of coded blocks. In an example, the one or more MV buffers can be initialized at the start of coding each partition of the current frame. For example, before coding a tile of the current block that includes the current block, the one or more MV buffers can be initialized. Initializing an MV buffer can mean or can include allocating memory for the MV buffer so that MVs of coded blocks can be stored in the MV buffer. Responsive to completing coding of the partition, the MV buffers can be reset (e.g., deleted, deallocated, etc.).

MV buffers may be grouped into MV banks. As such, the technique 900 can include initializing the MV banks in an example. Initializing an MV bank can include initializing MV buffers of the MV bank. Each MV buffer of an MV bank corresponds to a reference frame type. To illustrate, and without limitation, a row MV buffer that corresponds to the reference frame type BWDREF can be used to store motion vectors of blocks (e.g., motion units) of that row of superblocks that are coded using the reference frame type BWDREF.

In an example, respective MV banks can be associated with rows of superblocks of a partition of the current frame. In an example, respective MV banks can additionally or alternatively be associated with columns of superblocks of the partition of the current frame. In an example, a row MV bank can be associated with more than one rows of the partition. In an example, a column MV bank can be associated with more than one columns of the partition. To illustrate, and without limitation, each row MV bank can be associated with two rows of superblocks of the partition and each column MV bank can be associated with three columns of superblocks of the partition.

The MV banks can provide long term motion dependencies that are not captured by scanning a neighborhood of a current block for motion vectors where the neighborhood is conventionally a few units of pixels (or blocks) adjacent to the current block. Longer term motion dependencies can mean longer distance motion vectors from the current block or motion vectors of pixels or blocks distant from the current block.

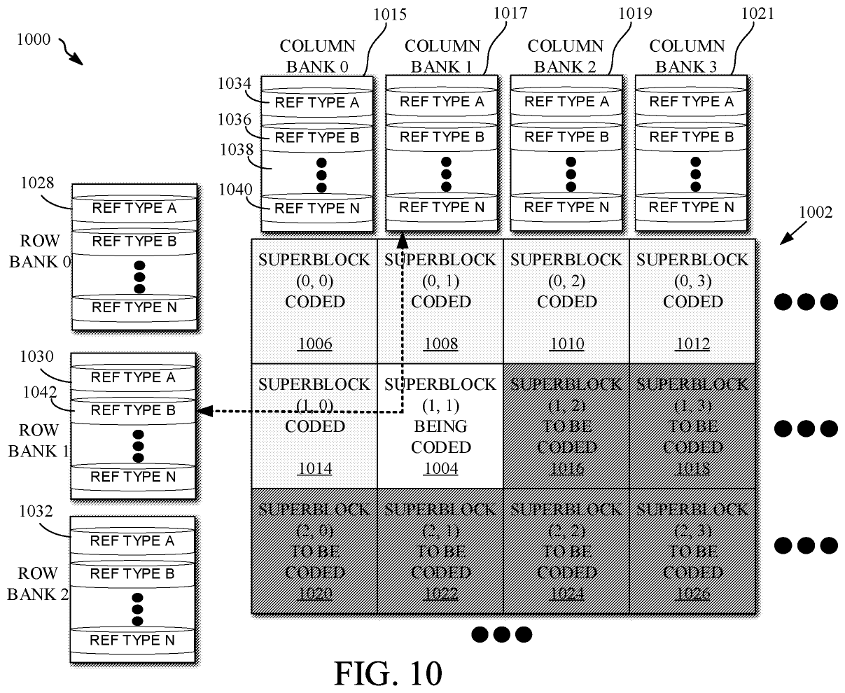

FIG. 10 is a diagram of an example 1000 of motion vector banks. The example 1000 includes a frame portion 1002 of a current frame being coded. The frame portion 1002 can be a tile of the current frame, a segment of the current frame, the current frame itself, or some other partition of the current frame. The example 1000 illustrates that the frame portion 1002 includes 4 rows of superblocks and 4 columns of superblocks. However, the disclosure is not so limited: the number of rows of superblocks and the number of columns of superblocks can depend on the width and height (such as in pixels) of the frame portion 1002 and the superblock size.

The example 1000 illustrates that a superblock 1004 is a current superblock being coded. Superblocks 1006 through 1014 have already been coded. While not specifically shown in FIG. 10, a person skilled in the art recognizes that each of the superblocks of the frame portion 1002 may be further partitioned into smaller blocks, which are coded.

In the example 1000, a column MV bank 1015 is associated with column 0 of the superblocks, which includes at least superblocks 1006, 1014, and 1020; a column MV bank 1017 is associated with column 1 of the superblocks, which include at least superblocks 1008, 1004, and 1022; a column MV bank 1019 is associated with column 2 of the superblocks, which includes at least superblocks 1010, 1016, and 1024; a column MV bank 1021 is associated with column 3 of the superblocks, which includes at least superblocks 1012, 1018, and 1026; a row MV bank 1028 is associated with row 0 of the superblocks, which includes at least superblocks 1006, 1008, 1010, and 1012; a row MV bank 1030 is associated with row 1 of the superblocks, which includes at least superblocks 1014, 1004, 1016, and 1018; and a row MV bank 1032 is associated with row 2 of the superblocks, which includes at least superblocks 1020, 1022, 1024, and 1026.

Each of the MV banks in the example 1000 is shown to include an MV buffer for each of available reference frame types A through N. For example, the column MV bank 1015 is illustrated as including MV buffer 1034, 1036, 1038, 1040 corresponding to the reference frame types A, B, . . . , N, respectively. In an example, each of the MV banks can be initialized to include respective MV buffers for the available reference frame types. In another example, MV buffers in MV banks may be allocated on demand. That is, an MV buffer corresponding to a reference frame type can be allocated in response to encountering a very first block that uses the reference frame type.

The MVs of blocks of a superblock that are coded using inter-prediction are added to the corresponding MV buffer(s) of the corresponding MV bank(s). The MVs can be added to an MV buffer as blocks are coded (e.g., after coding of a block is completed or after the MV of the block is obtained). In another example, the MVs of all blocks of superblock can be added after all blocks of a superblock have been coded. To illustrate, after all blocks of the superblock 1014 are coded, the MVs of the all blocks of the superblock 1014 can be added to the corresponding MV buffers. For example, the MV of an inter-coded block using the reference frame type B of the superblock 1014, the MV can be added to an MV buffer 1042 of the row MV bank 1030 and the MV buffer 1036 of the column MV bank 1015.

Some implementations may only use row MV banks or row MV buffers; other implementations may use column MV banks or column MV buffers; and yet other implementations may use both row and column MV banks or buffers. Coding superblocks typically proceeds in a raster scan order. As such, MVs of all blocks of a row of superblocks can be added to one MB bank. As coding proceeds from one superblock to the next superblock in the row, the same row MV bank can be updated. However different column MV buffers (or banks) are used as coding proceeds from superblock to a next in the raster order.

It is noted that with respect to an encoder, the MV of a coded block can mean or include the MV that was selected by the encoder (such as based on a rate-distortion measure) for encoding the block; and with respect to a decoder, the MV of a coded blocks can mean or include the MV that the decoder uses (and which may be determined based on syntax elements in a compressed bitstream) to obtain a prediction block of the block.

Referring again to FIG. 9, at 902, the technique 900 codes a first block of a current frame using a first motion vector (MV) and a reference frame type. To illustrate, the first block can be, or can be a block of, the superblock 1008 of FIG. 10; or the first block can be, or can be a block of, the superblock 1014 of FIG. 10. In an example, and more generally, the process codes first blocks of the current frame that precede the current block to be coded. The first blocks may be coded using respective reference frame types. In an example, the current frame may be partitioned, such as into tiles, segments, or some other partitions. For brevity, a frame that is not partitioned may still be referred as a partitioned frame that is partitioned into one partition that is coextensive with the frame. The technique 902 codes the first blocks that precede the current block in the same partition (e.g., tile, segment, etc.) as the current block. As mentioned, the reference frame type can be or correspond to a single reference frame prediction mode; or the reference frame type can be or correspond to a compound reference frame prediction mode.

At 904, the technique 900 stores, in at least one MV buffer, the first MV and the reference frame type. To illustrate, and assuming that the reference frame type is the reference frame type B, the at least one MV buffer can be at least one of the MV buffer 1042 or the MV buffer 1036 of FIG. 10. In an example, the reference frame type may already be associated with the at least one MV buffer. As such, the reference frame type may not be explicitly stored in the at least one MV buffer. Rather, the reference frame type is considered stored in the at least one MV buffer as the at least one MV buffer is associated with the at least one MV buffer.

The at least one MV buffer can include an MV buffer that is associated with a row of superblocks of the current frame. In an example, the at least one MV buffer can be associated with a row of superblocks or a column of superblocks of a tile of the current frame. In an example, the at least one MV buffer can be associated with a row of superblocks or a column of superblocks of a segment of the current frame. In an example, the at least one MV buffer can additionally or alternatively include an MV buffer that is associated with a column of superblocks of the current frame.

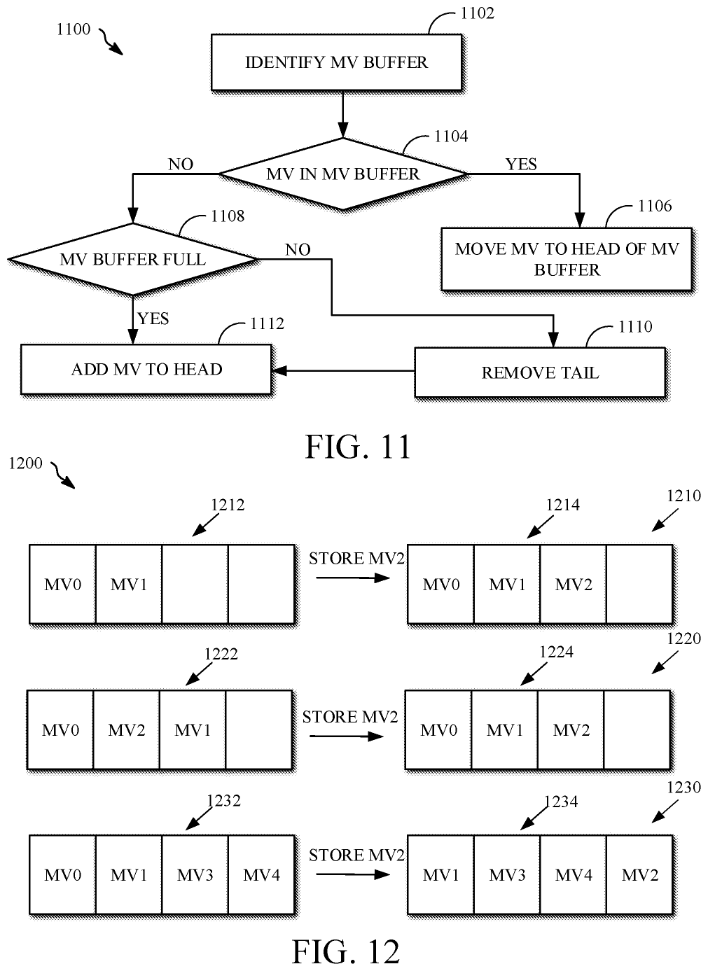

The first MV can be added to the at least one MV buffer in any number of ways. In an example, the first MV can be added to a next open slot of the at least one MV buffer. In another example, if the first MV is already included in the at least one MV buffer, then the first MV is not added a second time. In another example, storing the first MV in the at least one MV buffer can be as described with respect to FIGS. 11 and 12.

FIG. 11 is a flowchart diagram of a technique 1100 for adding a motion vector to a motion vector buffer. The technique 1100 can be performed for each MV of blocks of a superblock. The technique 1100 can be performed after coding each block of the superblock or after all blocks of the superblock have been coded. While the technique 1100 is described with respect to a motion vector (e.g., in the singular), in the case of a compound reference frame prediction mode, the motion vector in fact includes two motion vectors, as already mentioned. As such, “a motion vector” encompasses one motion vector or two motion vectors, depending on the frame reference type.

The technique 1100 is described with reference to FIG. 12. FIG. 12 illustrates scenarios of adding a motion vector to a motion vector buffer. The MV buffer can be a row MV buffer of a row MV bank. The MV buffer can be a column MV buffer of a column MV bank. In FIG. 12, scenarios 1210, 1220, and 1230 illustrate storing a motion vector MV2 in MV buffers under different conditions of the MV buffers. The MV buffer can be a fixed-size, first-in-first-out (FIFO), with reordering data structure. As is known, in a FIFO structure, elements are added at the tail (e.g., end, back) and removed from the head (e.g., start, front). The MV buffer can be ordered in the MV buffer such that MVs closer to the tail are used later in time than those closer to the head. That is, MVs are ordered in the MV buffer in last-used order.

At 1102, a motion vector to be added to an MV buffer is identified (e.g., chosen, selected, received, determined, etc.). The MV can be MV2 of FIG. 12.

At 1104, the technique 1100 determines whether the MV is already in the MV buffer. If the MV is in the MV buffer (such as illustrated in the scenario 1220), the technique 1100 proceeds to 1106 to move the MV to the head of the MV buffer; otherwise the technique 1100 proceeds to 1108. The scenario 1220 illustrates that MV2 is in the second location of an MV buffer 1222. As such, the MV buffer 1222 includes MV2, which indicates that a more distant block than an instant block used MV2. An MV buffer 1224 illustrates the result of 1106; namely, the MV buffer 1222 is reordered so that MV2 is moved to the tail of the MV buffer 1224.

At 1108, the technique 1100 determines whether the MV buffer is full. If the MV buffer is full (such as illustrated in the scenario 1230), the technique 1100 proceeds to 1110 to remove the head of MV buffer to make room for the MV at the tail of the MV buffer. If the MV buffer is not full (such as illustrated in the scenario 1210), the technique 1100 proceeds to 1112.

In the scenario 1230, the technique 1100 stores MV2 in an MV buffer 1232 that is full. The technique 1100 removes the oldest MV in the buffer, which is the MV at the head of the buffer (i.e., MV0) and adds MV2 to the tail of the buffer. An MV buffer 1234 illustrates the result of storing MV2 in the MV buffer 1232. In the scenario 1210, an MV buffer includes empty slots. As such, the technique 1100 stores MV2 in the tail of the MV buffer, as shown in an MV buffer 1214.

Accordingly, and referring again to FIG. 9, the technique 900 can include coding a second block of the current frame using a second MV and the reference frame type; and responsive to a determination that the at least one MV buffer is not full, adding the second MV to the at least one MV buffer. The technique 900 can also include, responsive to a determination that the at least one MV buffer is full, removing a previously added MV from the at least one MV buffer; and adding the second MV. The previously added MV can be at a head of the at least one MV buffer. In an example, a first MV can be stored anywhere in MV buffer except the tail and a second MV may be stored at the tail of the at least one and MV buffer. The technique 900 can further include, responsive to a determination that the first MV is used for coding a third block, moving the first MV to the tail of the at least one MV buffer, as illustrated with respect to the scenario 1220 of FIG. 12.

At 906, the technique 900 identifies MV candidates for coding a current block using the reference frame type. The current block can be, or can be a block of the superblock 1004 of FIG. 10. The MV candidates can be identified using any technique for identifying MV candidates in a neighborhood of the current block. A decoder may decode, from a compressed bitstream, the reference frame (e.g., an indication of the reference frame) to be used for decoding the current block, decode a mode, and decode one or more motion vectors. An encoder may select the reference frame using any technique for selecting the reference frame for coding the current block. Knowing the reference frame type to use, the decoder obtains a list of candidate motion vectors, which may be an ordered list. The ordered list can be generated at least by scanning pixels in the spatial neighborhood of the current block for the candidate motion vectors.

At 908, the technique 900 determines whether a cardinality (M) of the MV candidates is less than a maximum number of MV candidates (N). Stated another way, the technique 900 determines whether more slots are available in the list of MV candidates or whether M is less than N. If more slots are available, the technique 900 proceeds to 910. If no more slots are available, the technique 900 proceeds to 916.

At 910, the technique 900 identifies the first motion vector in the at least one MV buffer. In an example, the first motion vector may be randomly selected from the at least one MV buffer to be added to the candidate list (i.e., the MV candidates). In another example the at least one MV buffer can be an ordered list. The order of MVs in each buffer of the at least one MV buffer can be from oldest MV added to the buffer to most recently added MV. Identifying the first motion vector in the at least one MV buffer can include traversing the at least one MV buffer from the tail toward the head, and for each of the MVs, to determine whether the MV is already a candidate MV (i.e., whether the MV is on the candidate list of MVs).

As such, at 912, the technique 900 determines whether the first MV is included in the MV candidates. Responsive to a determination that the first MV is included in the MV candidates, the technique proceeds to 916. Responsive to a determination that the first MV is not included in the MV candidates, the technique 900 proceeds to 914.

At 914, the technique 900 adds the first MV as an MV candidate. That is, at 914, the technique 900 adds the first MV to the list of MV candidates. In an example the technique 900 can include, responsive to a determination that the cardinality of the MV candidates is less than the maximum number of MV candidates and the first MV is included in the MV candidates, identifying, in the at least one MV buffer, another MV that is different from the first MV and that is not included in the MV candidates; and adding the other MV as an MV candidate.

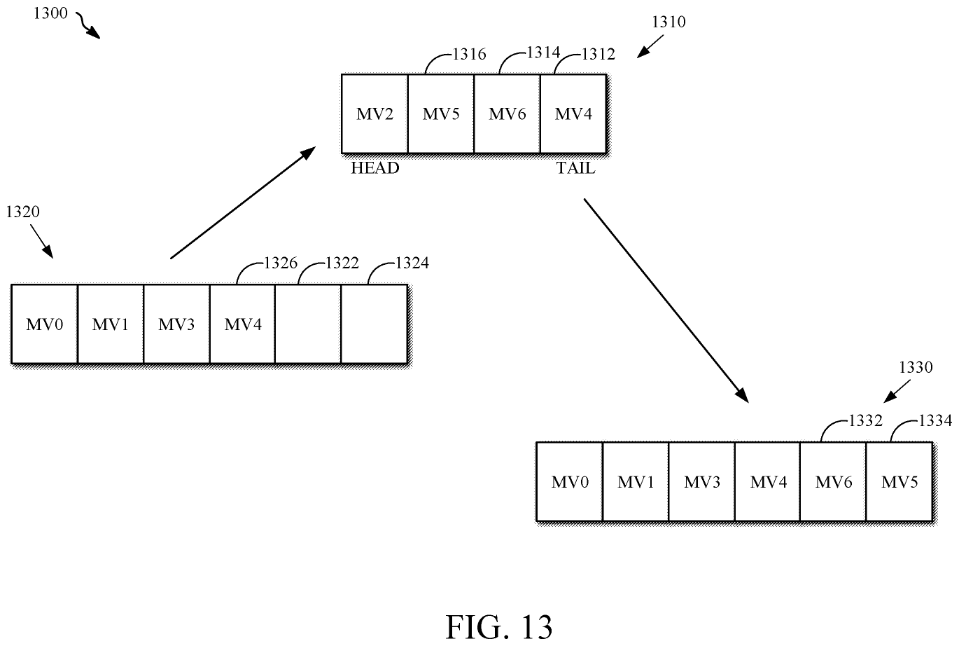

FIG. 13 illustrates an example 1300 of adding candidate motion vectors to a candidate motion vector list from a motion vector buffer. The example 1300 includes an MV buffer 1310 and a candidate MV list 1320. The MV buffer 1310 and the candidate MV list 1320 are shown as being of sizes 4 and 6, respectively. However, the MV buffer 1310 and the candidate MV list 1320 can include more or fewer number of MVs. A candidate MV list 1330 illustrates the state of the candidate MV list 1320 after MVs are added to the candidate MV list 1320 from the MV buffer 1310.

As already described, after conventional reference MV candidate scanning is done (e.g., after an MV candidate list is conventionally obtained), if there are open slots in the MV candidate list, a codec can reference the MV candidate banks (more specifically, the buffer with a matching reference frame type) for additional MV candidates. Going from the tail backwards to the head of the MV buffer, the MV in the buffer can be appended to the MV candidate list if the MV does not already exist in the MV candidate list.

The MV buffer 1310 includes, from head to tail, the motion vectors MV2, MV5, MV6, and MV4. The candidate MV list 1320 includes the motion vectors MV0, MV1, MV3, and MV4. Two slots (e.g., positions) of the candidate MV list 1320 are empty; namely, slots 1322, 1324. Starting from the tail, the MV at slot 1312 (i.e., MV4) of the MV buffer 1310 is first examined. The technique 900 determines that the candidate MV list 1320 already includes MV4 in the slot 1326. Next, the technique 900 considers MV6 (i.e., the MV in a next slot 1314 of the MV buffer 1310). As the candidate MV list 1320 does not include MV6, the technique 900 adds MV6 as a candidate, as shown in a slot 1332 of the candidate MV list 1330. Next, the technique 900 considers MV5 (i.e., the MV in a next slot 1316 of the MV buffer 1310). As the candidate MV list 1320 does not include MV5, the technique 900 adds MV5 as a candidate, as shown in a slot 1334 of the candidate MV list 1330. As the candidate MV list 1330 is now full, the technique 900 stops evaluating other MVs in the MV buffer 1310.

In some situations, slots in the candidate MV list may still be available after evaluating all of the MVs in an MV buffer. As already mentioned, in some implementations, two MV buffers may be available: a row MV buffer and a column MV buffer. The technique 900 may use one of the two MV buffers first. For example, the row (or column) MV buffer may be used first. If more slots remain available in the candidate MV list, the technique 900 can add more candidates from the other MV buffer as described with respect to FIG. 13.

Referring to FIG. 9 again, at 916, the technique 900 selects one of the MV candidates for coding the current block, as described above. When implemented in a decoder, the one of the MV candidates may be selected by decoding an index of the one of the MV candidates from the compressed bitstream. When implemented in an encoder, the encoder can encode, in the compressed bitstream the index of the one of the MV candidates. As described above, the one of the MV candidates can itself be used code the current block—the candidate may be used as a reference MV for differential coding of MV of the current block. The one of the MV candidates may be used in other ways to code the current block.

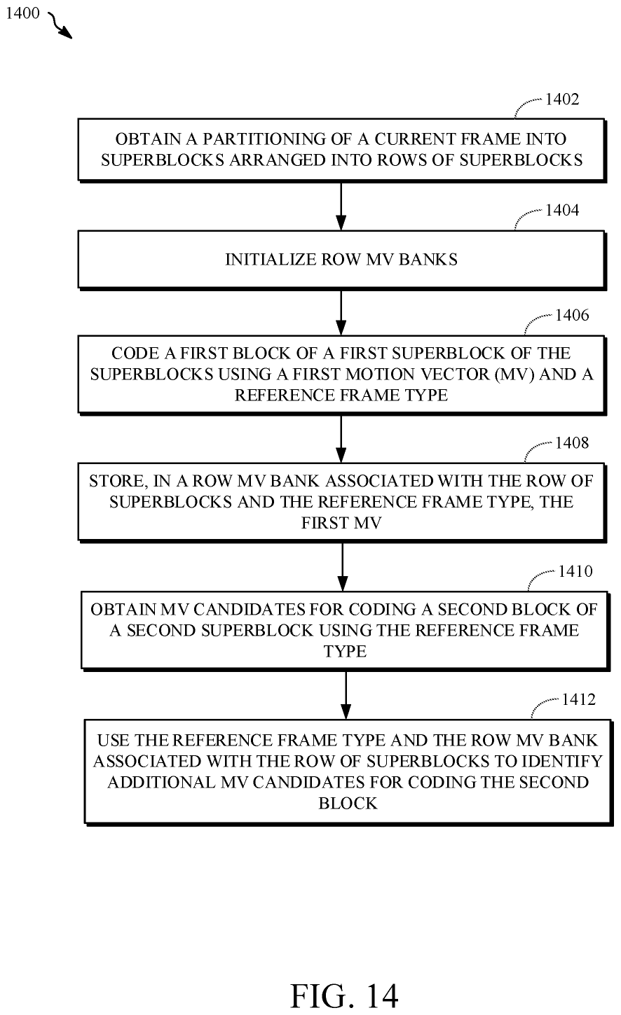

FIG. 14 is a flowchart diagram of a technique 1400 for obtaining motion vector candidates. The technique 1400 may be implemented in whole or in part in the intra/inter prediction stage 402 of the encoder 400 of FIG. 4 and/or the intra/inter prediction stage 508 of the decoder 500 of FIG. 5. When implemented in an encoder, “to code” means “to encode”; when implemented by a decoder, “to code” means “to decode”.

The technique 1400 can be implemented, for example, as a software program that may be executed by computing devices such as the transmitting station 102 or the receiving station 106 of FIG. 1. For example, the software program can include machine-readable instructions that may be stored in a memory such as the memory 204 or the secondary storage 214 of FIG. 2, and that, when executed by a processor, such as CPU 202 of FIG. 2, may cause the computing device to perform the technique 1400. The technique 1400 can be implemented using specialized hardware or firmware. As explained above, some computing devices may have multiple memories or processors, and the operations described in the technique 1400 can be distributed using multiple processors, memories, or both. The technique 1400 can be implemented using specialized hardware or firmware. Multiple processors, memories, or both, may be used.

At 1402, the technique 1400 obtains a partitioning of a current frame into superblocks, wherein the superblocks are arranged into rows of superblocks, as described herein. At 1404, the technique 1400 initializes row MV banks. Each row MV bank can be associated with one or more rows of superblocks and one or more reference frame types. A row MV bank can include one or more MV buffers, as described herein. Each MV buffer can be associated with a reference frame type. As described herein, an MV buffer can store motion vectors. In the case that the reference frame type associated with an MV buffer indicates a singular reference frame, then each MV stored at a slot of the MV buffer is a single MV; and in the case that the reference frame type associated with an MV buffer indicates a compound reference frame, then each MV stored at a slot of the MV buffer is in fact two MVs.

At 1406, the technique 1400 codes a first block of a first superblock of a row of superblocks of the superblocks using a first motion vector (MV) and a reference frame type. The first block can be coded as described with respect to 904 of FIG. 9. At 1408, the technique 1400 stores, in a row MV bank associated with the row of superblocks and the reference frame type, the first MV. The first MV can be stored in the row MV bank as described above. At 1410, the technique 1400 obtains MV candidates for coding a second block of a second superblock using the reference frame type. The technique 1400 can obtain the MV candidates using any conventional technique for obtaining MV candidates.

At 1412, on a condition that a cardinality of the MV candidates is less than a maximum number of MV candidates, the technique 1400 uses the reference frame type and the row MV bank associated with the row of superblocks to identify additional MV candidates for coding the second block. In an example, the technique 1400 can search the row MV bank for an MV that is not included in the MV candidates to add the MV to the MV candidates. The technique 1400 can search the row MV bank from a most recently added MV to an oldest added MV.

The first block can be in a column of the superblocks. Then, the technique 1400 can further include initializing column MV banks and storing, in a column MV bank associated with the column of the superblocks of and the reference frame type, the first MV. Each column MV bank can be associated with one or more columns of the superblocks and the one or more reference frame types. In an example, the technique 1400 can search the row MV bank before searching the column MV bank for an MV that is not included in the MV candidates to add the MV to the MV candidates.

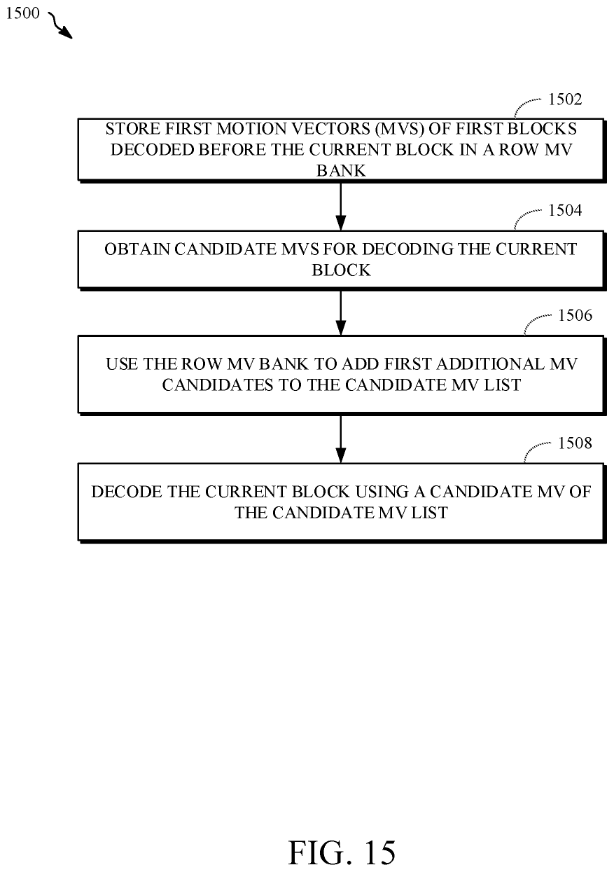

FIG. 15 is a flowchart diagram of a technique 1500 for decoding a current block. The technique 1500 may be implemented in whole or in part in the intra/inter prediction stage 508 of the decoder 500 of FIG. 5. The technique 1500 can be implemented, for example, as a software program that may be executed by computing devices such as the transmitting station 102 or the receiving station 106 of FIG. 1. For example, the software program can include machine-readable instructions that may be stored in a memory such as the memory 204 or the secondary storage 214 of FIG. 2, and that, when executed by a processor, such as CPU 202 of FIG. 2, may cause the computing device to perform the technique 1500. The technique 1500 can be implemented using specialized hardware or firmware. As explained above, some computing devices may have multiple memories or processors, and the operations described in the technique 1500 can be distributed using multiple processors, memories, or both. The technique 1500 can be implemented using specialized hardware or firmware. Multiple processors, memories, or both, may be used.

At 1502, the technique 1500 stores first motion vectors (MVs) of first blocks decoded before the current block in a row MV bank. The row MV bank can be associated with a row of superblocks that includes the first blocks and the current block, as described above with respect to FIG. 9. At 1504, the technique 1500 obtains candidate MVs for decoding the current block. The candidate MVs can be stored in slots of a candidate MV list. The cardinality of the candidate MVs is smaller than a size of the candidate MV list. The candidate MVs can be obtained in any conventional technique for obtaining candidate MVs.

At 1506, the technique 1500 uses the row MV bank to add first additional MV candidates to the candidate MV list, as described above. At 1508, the technique 1500 decodes the current block using a candidate MV of the candidate MV list.

In an example, the technique 1500 can further include storing second motion vectors (MVs) of second blocks decoded before the current block in a column MV bank and using the column MV bank to add second additional MV candidates to the candidate MV list. The column MV bank can be associated with a column of superblocks that includes the second blocks and the current block.

For simplicity of explanation, the techniques 900, 1100, 1400, and 1500 of FIGS. 9, 11, 14, and 15, respectively, are depicted and described as series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

1. A method for inter-prediction, comprising:
coding a first block of a current frame using a first motion vector (MV) and a reference frame type;
storing, in at least one MV buffer, the first MV and the reference frame type, wherein the first MV is associated with a reference frame, and wherein the reference frame type is indicative of a role associated with the reference frame as stored in the at least one MV buffer;
identifying MV candidates for coding a current block using the reference frame type;
responsive to a determination that a cardinality of the MV candidates is less than a maximum number of MV candidates:
identifying the first motion vector in the at least one MV buffer; and
adding the first MV as an MV candidate; and
selecting one of the MV candidates for coding the current block.

2. The method of claim 1, further comprising:
coding a second block of the current frame using a second MV and the reference frame type; and
responsive to a determination that the at least one MV buffer is not full, adding the second MV to the at least one MV buffer.

3. The method of claim 2, further comprising:
responsive to a determination that the at least one MV buffer is full:
removing a previously added MV from the at least one MV buffer; and
adding the second MV.

4. The method of claim 3, wherein the previously added MV is at a head of the at least one MV buffer.

5. The method of claim 2,
wherein the at least one MV buffer is an ordered list, and
wherein the second MV is stored at a tail of the at least one MV buffer, the method further comprising:
responsive to a determination that the first MV is used for coding a third block, moving the first MV to the tail of the at least one MV buffer.

6. The method of claim 1, further comprising:
responsive to a determination that the cardinality of the MV candidates is less than the maximum number of MV candidates and the first MV is included in the MV candidates,
identifying, in the at least one MV buffer, another MV that is different from the first MV and that is not included in the MV candidates; and
adding the other MV as another MV candidate.

7. The method of claim 6, wherein identifying, in the at least one MV buffer, the other MV comprises:
searching the at least one MV buffer starting at a tail of the at least one MV buffer to identify the other MV.

8. The method of claim 1, wherein the reference frame type corresponds to a single reference frame prediction mode.

9. The method of claim 1, wherein the reference frame type corresponds to a compound reference frame prediction mode.

10. The method of claim 1, wherein the at least one MV buffer is associated with a row of superblocks or a column of superblocks of a tile of the current frame.

11. The method of claim 1, wherein the at least one MV buffer is associated with a row of superblocks or a column of superblocks of a segment of the current frame.

12. An apparatus for inter-prediction, comprising:
a processor configured to:
obtain a partitioning of a current frame into superblocks, wherein the superblocks are arranged into rows of superblocks;
initialize row MV banks,
wherein each row MV bank is associated with one or more rows of superblocks and one or more reference frame types;
code a first block of a first superblock of the superblocks using a first motion vector (MV) and a reference frame type, wherein the first block is in a row of superblocks;
store, in a row MV bank associated with the row of superblocks and the reference frame type, the first MV, wherein the first MV is associated with a reference frame and the reference frame type is indicative of a role associated with the reference frame as stored in the row MV bank;
obtain MV candidates for coding a second block of a second superblock using the reference frame type; and
on a condition that a cardinality of the MV candidates being less than a maximum number of MV candidates, use the reference frame type and the row MV bank associated with the row of superblocks to identify additional MV candidates for coding the second block.

13. The apparatus of claim 12, wherein to use the row MV bank associated with the row of superblocks and the reference frame type to identify the additional MV candidates for coding the second block comprises to:
search the row MV bank for an MV that is not included in the MV candidates to add the MV to the MV candidates.

14. The apparatus of claim 12, wherein the row MV bank is searched from a most recently added MV to an oldest added MV.

15. The apparatus of claim 12,
wherein the first block is in a column of the superblocks, and
wherein the processor is further configured to:
initialize column MV banks, wherein each column MV bank is associated with one or more columns of the superblocks and the one or more reference frame types; and
store, in a column MV bank associated with the column of the superblocks of and the reference frame type, the first MV.

16. The apparatus of claim 15, wherein to use the row MV bank associated with the row of superblocks and the reference frame type to identify the additional MV candidates for coding the second block comprises to:
search the row MV bank before searching the column MV bank for an MV that is not included in the MV candidates to add the MV to the MV candidates.

17. The apparatus of claim 12, wherein the reference frame type corresponds to single-reference prediction.

18. The apparatus of claim 12, wherein the reference frame type corresponds to a compound-reference prediction.

19. A method for decoding a current block of a current frame, comprising:
storing first motion vectors (MVs) of first blocks decoded before the current block in a row MV bank, wherein the row MV bank is associated with a row of superblocks that includes the first blocks and the current block, wherein the first MVs are associated with respective reference frame types, and wherein the row MV bank is organized based on the reference frame types;
obtaining candidate MVs for decoding the current block, wherein the candidate MVs are stored in slots of a candidate MV list, and a cardinality of the candidate MVs is smaller than a size of the candidate MV list;
using the row MV bank to add first additional MV candidates to the candidate MV list; and
decoding the current block using a candidate MV of the candidate MV list.

20. The method of claim 19, further comprising:
storing second motion vectors (MVs) of second blocks decoded before the current block in a column MV bank, wherein the column MV bank is associated with a column of superblocks that includes the second blocks and the current block; and
using the column MV bank to add second additional MV candidates to the candidate MV list.
